(19) United States
(12) Patent Application Publication
(10) Pub. No.: US 2005/0035256 A1
(43) Pub. Date: Feb. 17, 2005

(54) Clamp for fixing elongated part and use of such a clamp

(76) Inventor: Ulrik Bruhn, Sonderborg (DK)

Correspondence Address: HARNESS, DICKEY & PIERCE, P.L.C., P.O. BOX 8910, RESTON, VA, 20195, US

(21) Appl. No.: 10/496,884

(22) PCT Filed: Nov. 26, 2002
(86) PCT No.: PCT/DK02/00791

(30) Foreign Application Priority Data
Nov. 27, 2001 (DK) PA 2001 01764

(51) Int. Cl. A47G 1/10

(52) U.S. Cl. 248/316.1

(57) ABSTRACT

Clamp for fixing elongated parts (30) to a grippable element (31) of a support, said clamp (1) comprising a base (2) with legs (3, 4) extending substantially in parallel, and further comprising at least two jaws (7, 8), being mutually connected and displaceable in the direction towards each other, and having on their outer sides wedge-shaped members (14, 17), said wedge-shaped members having a pointed end (15, 18), which is meant to be directed towards the legs (3, 4) during use, and an oppositely directed blunt end (16, 19), the legs on the base being meant for displacement over the wedge-shaped members of the jaws, said wedge-shaped members hereby displacing the jaws towards each other. Thus, it is achieved that a force applied on the base in a direction in parallel with the legs projecting from the base, and which results in a displacement of base and legs in this direction in relation to the jaws, will produce a closing movement of the jaws around the elongated part and the grippable element of the support, in such a way that the elongated part is fixed to the support. The clamp is easily and quickly fitted and cheap in manufacturing.

The invention concerns a clamp for fixing elongated parts to a grippable element of a support, said clamp comprising a base with legs extending substantially in parallel, and further comprising at least two jaws, which are mutually connected and displaceable in the direction towards each other. The invention also concerns the use of such a clamp.

From WO 97/23744 is known a monolithic pipe clamp made of a plastic material for fixing pipes on a support The clamp comprises a base intended to be attached to the support before the fixing of the pipe, and two arched and mutually connected wings, the wings being displaced towards each other, when, during fitting, the pipe presses against the connecting element of the wings. The ends of the wings are provided with snap arrangements, which engage with each other, when the pipe is completely surrounded by the wings. The clamp is dedicated for one particular pipe diameter and requires a relatively exact orientation in relation to the pipe.

A more flexible arrangement for fixing elongated parts to a support is known as cable strip and, for example, described in WO 00/69744. Such cable strips comprise an elongated, flexible tail section having a toothing formed on substantially the entire length of the tail section, and a head section arranged at one end of the tail section. The head section comprises an opening in which is arranged a locking device that engages with the toothing on the tail section, when the free end of the tail section is inserted in and pulled through the opening of the head section with the purpose of forming a noose.

The handling of such cable strips is relatively slow, requires sufficient space around the part and the support, and both hands are needed to perform closing and tightening of the noose and possible cutting off the excess piece of the tail section, which has been pulled through the head section. Besides, this cutting off often results in a relatively sharp cutting edge, which can cause injuries to the operating staff.

The task of the invention is to provide a clamp, which is easier and faster to fit, and which is cheap in production.

With a clamp as described in the introduction, this task is solved in that the outer sides of the jaws are provided with outwardly directed wedge-shaped members, the wedge-shaped members having a pointed end, which is meant to be directed towards the legs of the base during use, and an oppositely directed, blunt end, and that the legs are meant to be displaced over the wedge-shaped members on the jaws, the wedge-shaped members hereby displacing the jaws towards each other. Thus, it is achieved that a force applied on the base in a direction, which is parallel to the legs projecting from the base, and a resulting displacement of base and legs in this direction in relation to the jaws, will produce a closing movement of the jaws around the elongated part and the element, capable of being gripped, of the support, causing the elongated part to be fixed to the support.

Advantageously, the wedge-shaped members on the jaws are provided with an outer projection and the legs on the base are provided with a corresponding inner projection, the outer projection and the inner projection being meant to engage with each other, when the legs have been displaced by a predetermined distance over the wedge-shaped members, with the purpose of securing the displacement of the jaws in relation to each other.

This snap arrangement provides a certain securing of the mutual position of the jaws, when the legs have moved for a predetermined distance along the wedge-shaped members and the inner projection on the legs has engaged with the projection formed on the wedge-shaped members. Fixing of the elongated part is thus ensured, even though the acting of a press force upon the base ceases.

Advantageously, the wedge-shaped members on the outer sides of the jaws are provided with an outer toothing, the legs on the base are provided with a corresponding inner toothing, the outer toothing and the inner toothing being meant for engaging with each other when the legs have been displaced by a predetermined distance over the wedge-shaped members on the jaws, to hereby secure the mutual, displaced position of the jaws.

This ensures an even better fixing of the elongated part on the support, as the mutually displaced position of the jaws is now locked by means of the toothings, when a press force acting upon the base makes the legs slide onto the wedge-shaped members of the jaws. It is avoided that the clamp can be pulled off again by mistake, which would cause the mounted and fixed parts to be released from the support.

In another embodiment, the inner sides of the clamp legs are provided with inwardly directed, wedge-shaped members, said wedge-shaped members having a pointed end, which is meant to be directed towards the jaws during use, and an oppositely directed blunt end, the legs and the wedge-shaped members on the inner sides of the legs being meant for displacement over the jaws, the wedge-shaped members hereby displacing the jaws towards each other.

The fact that the wedge-shaped members are now arranged on the inner sides of the legs, and the pointed ends of the members being directed towards the jaws, ensures a more compact outer shape of the clamp, which makes it more useful in places with limited working space.

Also this embodiment advantageously comprises a simple securing arrangement in the form of an inner projection on the wedge-shaped leg members, which engages with a corresponding outer projection on the jaws, when the legs have been displaced so far over the jaws that the outer projection has passed the inner projection.

Advantageously, in this embodiment, the jaws are provided with an outer toothing, the wedge-shaped members on the inner sides of the legs are provided with a corresponding inner toothing, the outer toothing and the inner toothing being meant to engage with each other, when the wedge-shaped members on the inner sides of the legs have been displaced by a predetermined distance over the jaws to hereby secure the displacement of the jaws in relation to each other.

Also here a safer fixing of the elongated part to the support is achieved by a locking of the jaw positions by means of the teeth.

Advantageously, the outer toothing and the inner toothing permit a stepwise displacement of the jaws towards each other and a securing of their positions in relation to each other, so that a first step causes a small displacement and a more remote securing of the jaws in relation to each other, and that successively subsequent steps cause a successively increased displacement and a closer securing of the jaws in relation to each other.

Thus, this also results in a stepwise locking of the jaw positions in relation to each other, when the outer and the inner toothings have engaged with each other. There are no specific limitations with regard to the size of the elongated part or the element, capable of being gripped, of the support, as the mutual position of the jaws can be locked in different positions.

Advantageously, the base and the jaws are mutually connected, and the mutual connection is realised by means of an articulation, said articulation permitting the jaws to be displaced towards each other, when the legs on the base are displaced over the jaws.

Thus, the clamp can be made as a single integrated unit, which is advantageous with regard to a simple manufacturing process. Besides, this feature facilitates the handling of the clamp, as the base with the legs and the jaws form a singled device.

The articulation between the base and the jaws is formed between the legs and the blunt end of the wedge-shaped members on the outer sides of the jaws, alternatively between the jaws and the pointed end of the wedge-shaped members on the inner sides of the legs.

The position and the flexibility of the articulation ensures that the legs and the jaws of the clamp are kept together as one part, in that during the mounting of the clamp the articulation follows the displacements between legs and jaws and the displacements between the jaws, without risking that the articulation gets jammed between the parts of the clamp and the elements and parts to be gripped by the clamp.

Advantageously, each jaw has an inner gripping surface, seen in a first direction from an outer opening between the jaws and inwardly along an inner side of the jaws, the inner gripping surface extending in portions in said first direction. A first, and in relation to the opening between the jaws, outer portion forms claws, each directed inwards towards the opposite jaw, a second, and in relation to the opening between the jaws, intermediate portion, forms a substantially rectilinear section of the jaws, and a third, and in relation to the opening between the jaws, inner portion forms an arched section of the jaws.

This embodiment of the claws makes it possible for the clamp to surround, grip and fix parts with different outer contours and dimensions. The inner, arched section forms the bearing surface towards the part to be fixed, the substantially rectilinear sections form the arms to surround this part and the grippable element of the support, and the outer, claw-shaped sections ensure the surrounding, gripping and fixing of the parts.

Preferably, each jaw has an inner gripping surface seen in a second direction along an opening between the jaws, said direction being the direction of the elongated part, when fixed by the clamp, and, in said second direction the jaws have at least one surface forming a sloping angle in relation to said second direction, preferably two oppositely arranged surfaces, each forming a sloping angle in relation to said second direction.

This embodiment enables the clamp to grip elongated parts at an angle, which is different from perpendicular in relation to the longitudinal axis of the part, or to grip parts, which are not arranged in parallel to each other. This is particularly advantageous when fixing flexible parts, like hoses or cables, as the demands on the positioning of the clamp in relation to the parts are less strict. The handling of the clamp is substantially facilitated.

Preferably, the end sections of the jaws are provided with toothings meant for engaging with each other, when, on using the clamp, the jaws are displaced so far towards each other that the end sections get in contact with each other.

This ensures an improved fixing of the surrounded and gripped parts, if appropriate in connection with the toothings on the wedge-shaped members.

Advantageously, the jaws are connected by means of a bridge element having on its upper side guide elements, said guide elements engaging with two wall sections formed on the long sides of the legs.

The control elements increase the stability of the clamp before mounting, as they prevent an unintended turning of the jaws in relation to the base with legs At the same time, the guide elements control the parallel displacement movement of the legs over the jaws during mounting of the clamp.

A clamp according to the invention is particularly useful for fixing a number of pipes to a network, such as a grid or another arrangement, which is the support of said number of pipes, preferably for fixing fluid pipes in a building to a grid in a floor, a wall or a ceiling, and even more preferred for fixing water pipes for hot water to a grid in a floor, primarily the floor of a bathroom.

Such hot water pipes, for example for a floor heating system, are easily and quickly fixed to a subjacent grid, as, with one single press on the base, the clamp will grip the pipe and the grid, without requiring access to the support under the grid, which is typically some sort of insulating material. This also applies for such places, where the pipes are not extending in parallel with the grid, for example in connection with pipe bends. The use of the clamp distinguishes itself by enabling fixing with one hand, while the other hand can be used to position the pipe in relation to the grid.

The use of a clamp according to the invention for fixing a number of cables or wires in cabling arrangements in buildings, preferably for fixing cables in grid shaped or perforated cable trays, results in a quick, easy and well-arranged cabling or wiring without the use of separate mounting tools. The available space around such cable trays is often narrow, but this can be overcome by the simple mounting method of the clamp. Fixing of the cables is obtained in that the jaws of the clamp grip one grid element of the cable tray, alternatively through two holes in the perforation of the tray. Also fixing of one cable to another cable arranged in the cable tray is possible.

A clamp according to the invention is advantageously used for fixing a number of wires, hoses or pipes to the body of a vehicle, said body forming the support for a number of wires, hoses or pipes, advantageously for fixing wires or hoses in the engine room of a vehicle, alternatively for fixing pipes in the engine room and along the bottom of the body of a vehicle.

Such bodies for vehicles are often characterised by difficult mounting conditions because of the large number of components to be arranged on the limited space available. The clamp is well suited for fixing hoses, pipes or wires to grippable elements of the body, for example to previously mounted hoses, pipes or wires.

In the following, the invention is described in detail with reference to the drawings, showing:

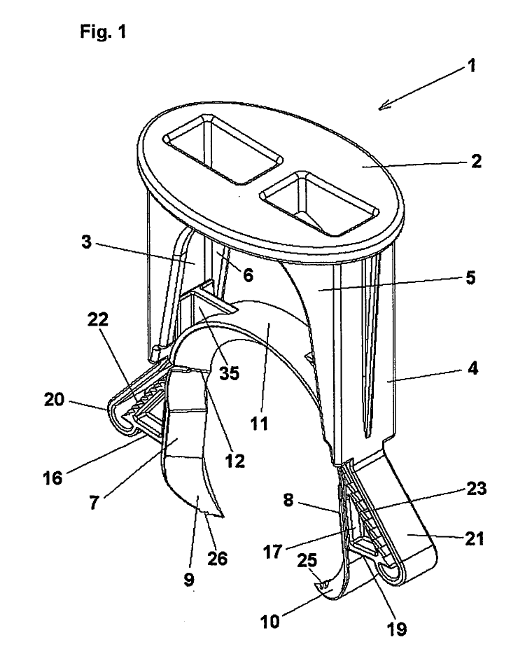

FIG. 1 a perspective view of a clamp according to the invention,

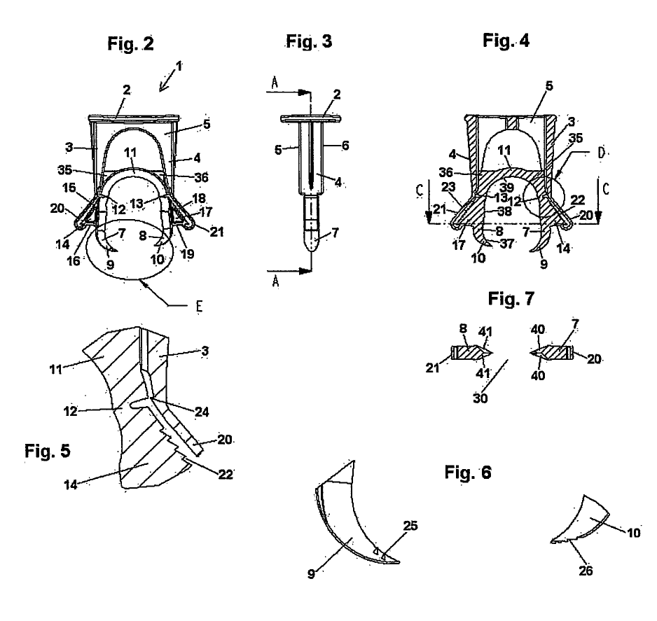

FIG. 2 a front view of a clamp according to the invention,

FIG. 3 a side view of the clamp according to FIG. 2,

FIG. 4 a vertical section through the clamp along the line A-A in FIG. 3,

FIG. 5 an enlarged section D of the section in FIG. 4,

FIG. 6 an enlarged section E of the clamp according to FIG. 2,

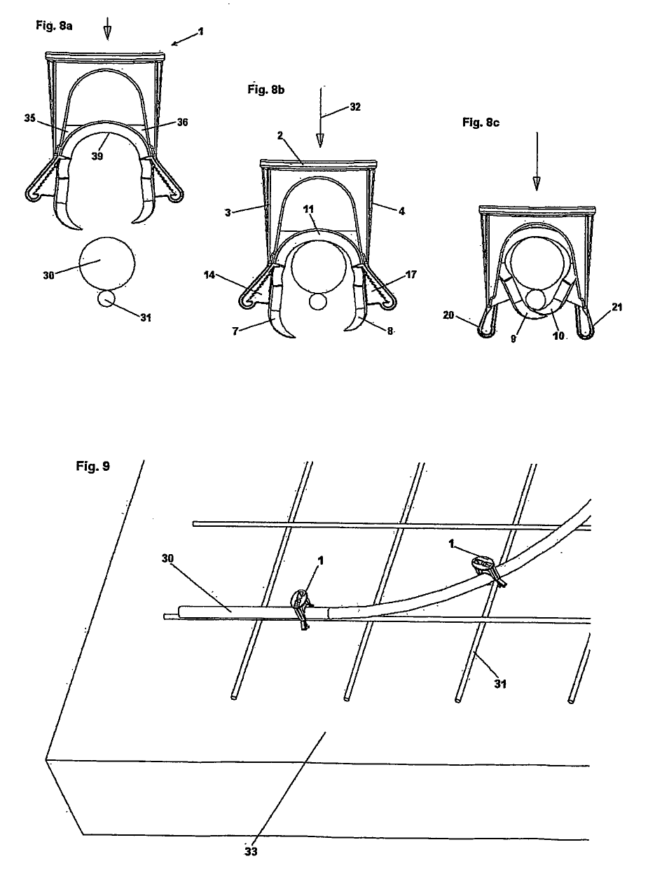

FIG. 7 a horizontal section through the clamp along the line C-C in FIG. 4,

FIG. 8a-8c shows the fitting course for a clamp for fixing a pipe,

FIG. 9 shows an application example of the clamp for fixing floor heating hoses to a grid,

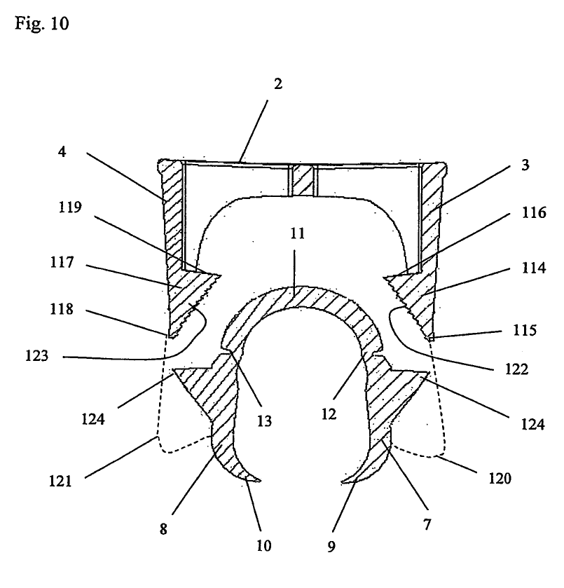

FIG. 10 shows a vertical section, as in FIG. 4, through another embodiment of the clamp.

The clamp 1 shown in FIGS. 1 to 3 comprises a base 2 with legs 3, 4 projecting perpendicularly and in parallel to each other from the base 2. The legs comprise two arched, parallel wall sections 5, 6, which connect the long sides of the legs and stabilise the legs in relation to the base 2.

The clamp also comprises two jaws 7, 8 with claw-shaped end sections 9, 10 pointing towards each other. An arched bridge element 11 connects the jaws 7, 8 with each other via two hinge sections 12, 13, which are formed at two areas in the jaws with reduced wall thickness, and which permit a displacement of the jaws in a direction towards each other. The upper side of the bridge element 11 is provided with guide elements 35, 36, which are in contact with the inner sides of the legs 3, 4 and the inner sides of the wall sections 5, 6.

On the outer side of the jaw 7 is formed a wedge-shaped member 14 with a pointed end 15 directed towards the base 2 of the clamp, and with a blunt end 16 directed away from the base 2. A corresponding wedge-shaped member 17 is formed on the outer side of the jaw 8 with a pointed end 18 and a blunt end 19, which are directed accordingly.

An articulation 20 in the form of a narrow, flexible band, connects the leg 3 with the blunt end 16 of the wedge-shaped member 14. An articulation 21 is formed between the leg 4 and the blunt end 19 of the wedge-shaped member 17.

Thus, all parts of the clamp are connected with each other. Advantageously, the clamp can therefore be manufactured as a single integrated plastic device by means of a suitable injection moulding process. The clamp is preferably made of polyamide (PA) or PVDE, but also other materials with suitable, flexible properties can be used.

As appears clearly from FIG. 4 and the enlarged section in FIG. 5, the outer sides of the wedge-shaped members 14, 17 are provided with toothings 22, 23. The inner sides of the legs 3, 4 are provided with one single toothing 24, meant to engage with the toothings 22, 23 on the wedge-shaped members.

As can also be seen from FIG. 4, the jaws 7, 8 do not have the same length. The end section 9 of the jaw 7 is made to be a little longer than the end section 10 of the jaw 8. In the closed state of the clamp, this makes it possible for the claw-shaped end section 9 to grip the end section 10.

FIG. 6 shows toothings 25 and 26 formed on the end sections 9 and 10, respectively, of the jaws, the toothing 25 formed on the upper side of the end section 9 and the toothing 26 formed on the bottom side of the end section 10 being meant for engaging with each other, when the end sections slide over each other during fitting of the clamp.

The horizontal section in FIG. 7 through the jaws 7, 8 shows the embodiment of the inner gripping surfaces 40, 41 of the jaws, which are arranged in a sloping angle in relation to a direction of an elongated part 30, shown in the drawing by means of dotted lines. In the example shown, the jaw 7 comprises two gripping surfaces 40 and the jaw 8 two gripping surfaces 41, which are angled in relation to each other to form a V-shaped profile for both jaws. This embodiment ensures that the jaws can also grip elongated parts, which are placed under an angle, which is different from the right angle shown between the elongated part and a connection line between the jaws.

Seen in a direction inwards from the end sections 9, 10 of the jaws, the gripping surfaces of the jaws comprise an outer claw-shaped section 37, then a rectilinear intermediary section 38 and an arched inner section 39 (see FIG. 4).

In the following, the mode of functioning of the clamp is illustrated by means of an example in FIGS. 8a to 8c, which illustrates the method of fitting a clamp 1 on an elongated part 30 with a circular cross-section, which is to be fixed on an element 31, capable of being gripped, for example a grid in a support. The part 30 is in contact with the grid element 31 (see FIG. 8a).

In FIG. 8b the clamp 1 is arranged on and in contact with the elongated part 30, in that the jaws 7, 8 have been arranged to surround both the part 30 and the element 31. The clamp is still open, and the gripping surface on the bridge element 11 has come to rest on the part 30. When now a press force is exerted on the base 2 in a direction as shown in the drawing by an arrow 32, the base 2 and the legs 3, 4 are displaced downward towards the jaws 7, 8. The guide elements slide in between the wall sections 5, 6 and the inner sides of the legs and ensure that the displacement is performed in parallel with the longitudinal axis of the jaws.

The toothings 24 on the inner sides of the lower ends of the legs will now get in contact with the pointed ends 15, 18 of the wedge-shaped members 14, 17. Due to the rigid embodiment of the legs and the relatively thin-walled hinged sections 12, 13, a continued displacement of the legs in the direction of the arrow 32, and the resulting pressure of the toothings 24 against the outer sides of the wedge-shaped members will cause the jaws to be bent inwards around the hinged sections 12, 13 and thus to be displaced in a direction towards each other. The longer the base 2 with the legs 3, 4 is moved downwards over the jaws, the more will the jaws with their claw-shaped end sections approach each other. The engagement of the toothings 22, 23, 24 with each other ensure that the relative position of the jaws is secured and locked in a given position, even though the pressing on the base 2 stops.

In FIG. 8c the clamp is completely closed. The upper side of the bridge element 11 has come to rest on the base 2, the legs 3, 4 have slid completely down over the wedge-shaped members, which has displaced the jaws so much towards each other that the end sections 9, 10 overlap each other, and also the toothings 25, 26 have engaged with each other. The elongated part 30 is now safely fixed on the grid element 31.

FIG. 9 illustrates an application example of the clamp for fixing floor-heating hoses 30 on a grid 31, which is arranged on an insulating layer 33. The clamps are shown in the open state, that is, before the jaws are displaced to grip both hose and grid by a press on the base of the clamp. One clamp shown is positioned in a bent hose section, where the hose crosses the grid under an angle. The angled gripping surfaces of the clamp makes it possible that during fitting, the clamp can grip both hose and grid safely and fix them to each other.

FIG. 10 shows a vertical section through another embodiment of the clamp, where, in relation to the first embodiment, the same reference numbers are used for corresponding parts. Reference numbers concerning the wedge-shaped members, the projections and the toothings are increased by one hundred.

In this embodiment inwardly directed wedge-shaped members 114 and 117 are arranged on the inner sides of legs 3 and 4, respectively. Wedge-shaped member 114 has a pointed end, directed towards the jaw 7, and a blunt end 116 facing the base 2. Correspondingly, wedge-shaped member 117 has a pointed end 118, directed towards the jaw 8, and a blunt end 119 facing the base 2. An inner toothing 123 is formed on the inner side of wedge-shaped member 117, an inner toothing 122 on the inner side of wedge-shaped member 114. Jaws 7 and 8 are provided with outwardly directed outer projections 124.

The clamp in FIG. 10 is shown as a two-part device, where the base 2 with legs 3, 4 is not connected with the jaws prior to use of the clamp. This embodiment allows a separate fitting of the jaws 7, 8, connected with each other by the bridge element 11, on the elongated part 30, intended to be fixed to a support, before applying the base 2 with the legs 3, 4. Such a device, allowing a two-step fixing operation, might be advantageous in automatic assembly lines. When the base part is fitted onto the pre-mounted part, which comprises the jaws 7, 8, in such a way that the legs 3, 4 are displaced in a sliding movement over the jaws, the latter will be displaced inwardly towards each other. The engagement of the wedge-shaped members 114, 117 and outer the projection 124 causes an inwardly bending movement of the jaws around hinged sections 12, 13. Again, an engagement of outer projection 124 with inner toothings 122, 123 allows a stepwise, secured and irreversible displacement of the jaws.

Of course, it is also possible to realize this embodiment of the clamp as a single-part device, by providing articulations 120, 121 between the pointed ends 115, 118 of the wedge-shaped members 114, 117 and the jaws 7, 8, as is indicated in FIG. 10 by dotted lines.

1. Clamp for fixing elongated parts to a grippable element of a support, said clamp comprising a base with legs, extending substantially in parallel, and further comprising at least two jaws, which are mutually connected and displaceable in the direction towards each other, wherein the outer sides of the jaws are provided with outwardly directed, wedge-shaped members, the wedge-shaped members having a pointed end, which is meant to be directed towards the legs of the base during use, and an oppositely directed, blunt end, and that the legs are meant to be displaced over the wedge-shaped members on the jaws, the wedge-shaped members hereby displacing the jaws towards each other.

2. Clamp according to claim 1, wherein the wedge-shaped members on the jaws are provided with an outer projection, and the legs on the base are provided with a corresponding inner projections, the outer projection and the inner projection being meant to engage with each other, when the legs have been displaced by a predetermined distance over the wedge-shaped members, with the purpose of securing the displacement of the jaws in relation to each other.

3. Clamp according to claim 1, wherein the wedge-shaped members on the outer sides of the jaws are provided with an outer toothing, the legs on the base are provided with a corresponding inner toothing, the outer toothing and the inner toothing being meant for engaging with each other when the legs have been displaced by a predetermined distance over the wedge-shaped members, to hereby secure the mutual, displaced position of the jaws in relation to each other.

4. Clamp for fixing an elongated part to a support, said clamp comprising a base with legs, extending substantially in parallel, and further comprising at least two jaws, which are mutually connected and displaceable in the direction towards each other, wherein the inner sides of the legs are provided with inwardly directed, wedge-shaped members, said wedge-shaped members having a pointed end, which is meant to be directed towards the jaws during use, and an oppositely directed blunt end and that the legs and the wedge-shaped members on the inner sides of the legs being meant for displacement over the jaws, the wedge-shaped members hereby displacing the jaws towards each other.

5. Clamp according to claim 4, wherein the wedge-shaped members on the legs are provided with an inner projection, that the jaws on their outer sides are provided with a corresponding outer projections, and that the outer projection and the inner projection are meant for engaging with each other, when the wedge-shaped members on the inner sides of the legs have been displaced by a predetermined distance over the jaws, to hereby secure the mutual displacement of the jaws.

6. Clamp according to claim 4, wherein the jaws on their outer sides are provided with an outer toothing, that the wedge-shaped members on the inner sides of the legs are provided with a corresponding inner toothing, and that the outer toothing and the inner toothing are meant to engage with each other, when the wedge-shaped members on the inner sides of the legs have been displaced by a predetermined distance over the jaws, to hereby secure the mutual displacement of the jaws.

7. Clamp according to claim 3, wherein the outer toothing and the inner toothing permit stepwise displacement and securing of the jaws towards each other, so that a first step causes a smaller displacement and a more remote securing of the jaws towards each other, and that successive steps cause a successively increased displacement and a closer securing of the jaws towards each other.

8. Clamp according to claim 4, wherein the base e and the jaws are mutually connected, and the mutual connection is formed by an articulation, and that the articulation permits a displacement of the jaws towards each other, when the legs being displaced over the jaws.

9. Clamp according to any of the claim wherein the articulation between the base and the jaws is formed between the legs on the base and the blunt end of the wedge-shaped members on the outer sides of the jaws.

10. Clamp according to any of the claims, wherein that the articulation between the base and the jaws is formed between the jaws and the pointed end of the wedge-shaped members on the inner sides of the legs

11. Clamp according to claim 4, wherein each jaw has an inner gripping surface seen in a first direction from an outer opening between the jaws and inwardly along an inner side of the jaws, that in said first direction the inner gripping surface extends in portions, that a first, and in relation to the opening between the jaws, outer portion forms claws each pointing inwards towards the opposite jaw, that a second, and in relation to the opening between the jaws, intermediate portion forms a substantially rectilinear section of the jaws, and that a third, and in relation to the opening between the jaws, inner portion forms an arched section of the jaws.

12. Clamp according to claim 1, wherein that each jaw has an inner gripping surface seen in a second direction along an opening between the jaws, which direction is the direction of the elongated part, when fixed by the clamp, and that in said second direction the jaws have at least one surface forming a sloping angle in relation to said second direction, but preferably has two oppositely arranged surfaces, each forming a sloping angle in relation to said second direction.

13. Clamp according to claim 1, wherein end sections of the jaws are provided with toothings meant for engaging with each other, when, during use of the clamp, the jaws are displaced so far towards each other that the end sections get in contact with each other.

14. Clamp according to claim 4, wherein the jaws are connected with a bridge element, and that the upper side of the bridge element is provided with guide elements, said guide elements engaging with two wall sections formed on the long sides of the legs.

15. Use of a clamp according to claim 4 for fixing a number of pipes to a network, such as a grid or another arrangement, forming the support of said number of pipes, preferably for fixing fluid pipes in a building to a grid in a floor, a wall or a ceiling of the building, more preferred for fixing water pipes for hot water to a grid in a floor, most preferred the floor in a bathroom.

16. Use of a clamp according to claim 4 for fixing a number of installation cables in cabling arrangements in buildings, preferably for fixing cables in grid shaped or perforated cable trays.

17. Use of a clamp according to claim 1 for fixing a number of wires, hoses or pipes to the body of a vehicle, said body forming the support for a number of wires, hoses or pipes, advantageously for fixing wires or hoses in the engine room of a vehicle, alternatively for fixing pipes in the engine room and along the bottom of the body of a vehicle.
